(19) United States
(12) Patent Application Publication
(10) Pub. No.: US 2020/0260561 A1
(43) Pub. Date: Aug. 13, 2020

(54) ELECTRONIC SYSTEM WITH PRESENTATION MECHANISM AND METHOD OF OPERATION THEREOF

(71) Applicant: Yume Cloud Inc., Mountain View, CA (US)

(72) Inventors: Daisuke YOSHIDA, Mountain View, CA (US); Kazuyuki Masuda, Mountain View, CA (US)

(21) Appl. No.: 15/781,550

(22) PCT Filed: Dec. 2, 2016
(86) PCT No.: PCT/US2016/064668

§ 371 Date: Jun. 5, 2018

Related U.S. Application Data
(60) Provisional application No. 62/263,623, filed on Dec. 5, 2015.

(51) Int. Cl. H05B 47/19; H05B 47/105; H05B 47/155

(52) U.S. Cl. CPC H05B 47/19; H05B 47/155; H05B 47/105

(57) ABSTRACT

A method of operation of an electronic system includes: detecting a sensing factor within a presentation context; determining a device relationship based on the sensing factor for establishing the device relationship between multiple instances of a device; and generating a presentation arrangement with a control unit for presenting a color arrangement at a luminosity level according to the device relationship for presenting on the device.

### CROSS-REFERENCE TO RELATED-APPLICATION(S)

The application claims the benefit of the U.S. Provisional Patent Application Ser. No. 62/263,623 filed Dec. 5, 2015, and the subject matter thereof is incorporated herein by reference thereto.

### TECHNICAL FIELD

The present invention relates generally to an electronic system, and more particularly to a system with presentation mechanism.

### BACKGROUND ART

Modern portable consumer and industrial electronics, especially client devices such as electronic systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world.” One such use of location based services is to efficiently transfer or route users to the desired destination or service.

Electronic systems and location based services enabled systems have been incorporated in automobiles, notebooks, handheld devices, and other portable products. Today, these systems aid users by incorporating available, real-time relevant information, such as maps, directions, local businesses, or other points of interest (POI). The real-time information provides invaluable relevant information.

However, an electronic system without presentation mechanism has become a paramount concern for the consumer. The inability decreases the benefit of using the tool.

Thus, a need still remains for an electronic system with presentation mechanism. In view of the increasing mobility of the workforce and social interaction, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic system including: detecting a sensing factor within a presentation context; determining a device relationship based on the sensing factor for establishing the device relationship between multiple instances of a device; and generating a presentation arrangement with a control unit for presenting a color arrangement at a luminosity level according to the device relationship for presenting on the device.

The present invention provides an electronic system, including: a detecting sensor for detecting a sensing factor within a presentation context; and a control unit, coupled to the detecting sensor, for: determining a device relationship based on the sensing factor for establishing the device relationship between multiple instances of a device, and generating a presentation arrangement with a control unit for presenting a color arrangement at a luminosity intensity according to the device relationship for presenting on the device.

The present invention provides an electronic system including a non-transitory computer readable medium including instructions for execution, the instructions comprising: detecting a sensing factor within a presentation context; determining a device relationship based on the sensing factor for establishing the device relationship between multiple instances of a device; and generating a presentation arrangement with a control unit for presenting a color arrangement at a luminosity intensity according to the device relationship for presenting on the device.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an electronic system with presentation mechanism in an embodiment of the present invention.

FIG. 2 is an example of the electronic system including the first device.

FIG. 3 is a first example of a presentation ensemble of multiple instances of the first device.

FIG. 4 is an exemplary block diagram of the electronic system.

FIG. 5 is a first control flow of the electronic system.

FIG. 6 is a flow chart of a method of operation of the electronic system in a further embodiment of the present invention.

FIG. 7 is a second example of a presentation ensemble of multiple instances of the first device.

FIG. 8 is a second control flow of the electronic system.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the electronic system 100 are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

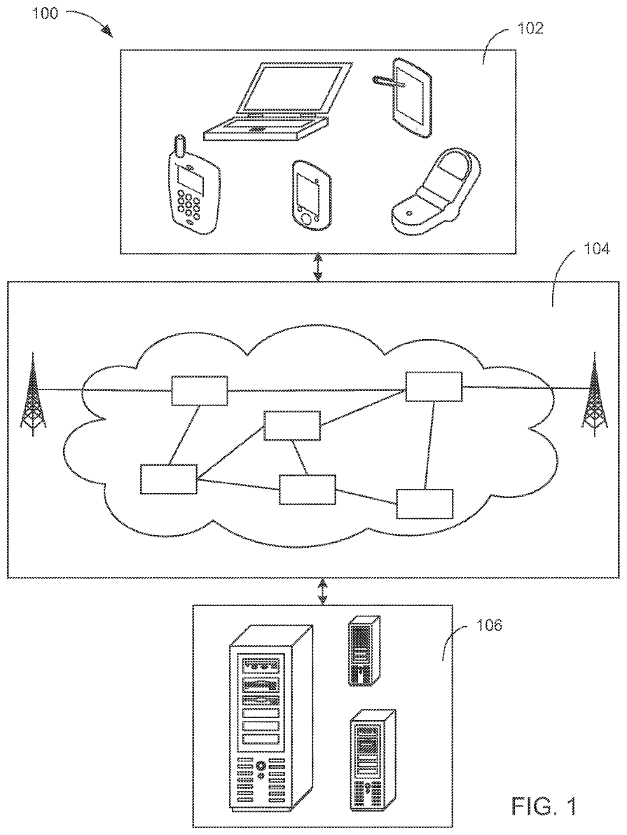

Referring now to FIG. 1, therein is shown an electronic system 100 with presentation mechanism in an embodiment of the present invention. The electronic system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic electronic system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the electronic system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a particularized machine, such as a mainframe, a server, a cluster server, rack mounted server, or a blade server, or as more specific examples, an IBM System z10™ Business Class mainframe or a HP ProLiant ML™ server.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102. Another example, the second device 106 can be a particularized machine, such as a portable computing device, a thin client, a notebook, a netbook, a smartphone, a tablet, a personal digital assistant, or a cellular phone, and as specific examples, an Apple iPhone™, Android™ smartphone, or Windows™ platform smartphone.

For illustrative purposes, the electronic system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. The communication path 104 can further include Bluetooth BLE, WiFi, ZigBee, other 900 MHz RFID, or a combination thereof.

Further, the communication path 104 can traverse a number of network topologies and distances. For example, the communication path 104 can include direct connection, personal area network (PAN), local area network (LAN), metropolitan area network (MAN), wide area network (WAN), mesh network, or any combination thereof.

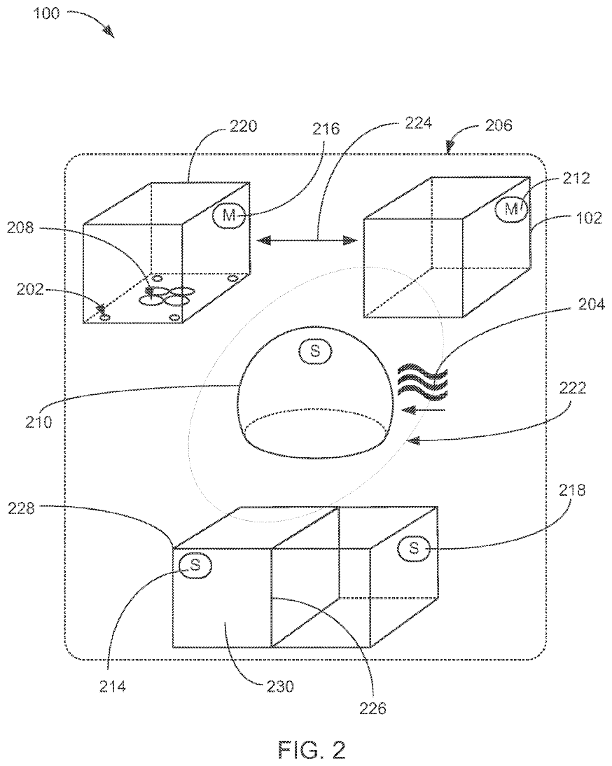

Referring now to FIG. 2, therein is shown an example of the electronic system 100 including the first device 102. For example, the first device 102 can represent a mobile entertainment device without functionality for the user of the first device 102 to communicate via oral communication, text communication, or a combination thereof. In contrast, the first device 102 can represent a mobile communication device including a smartphone to allow the user of the first device 102 to communicate via oral communication, text communication, or a combination thereof.

For clarity and brevity, the discussion of the embodiment of the present invention focuses on the first device 102 delivering the result generated by the electronic system 100. However, various embodiments of the present invention can easily be applied with the description with the second device 106 of FIG. 1 and the first device 102 interchangeably.

The first device 102 can include a detecting sensor 202. The detecting sensor 202 is defined as a device to detect, capture, or a combination thereof information. The first device 102 can include multiple instances of the detecting sensor 202. For example, the detecting sensor 202 can detecting a sensing factor 204 within a presentation context 206. For example, the sensing factor 204 can include can include rotation, speed, position, or a combination thereof of the first device 102. For another example, the sensing factor 204 can include sound, noise, vibration, or a combination thereof surrounding and/or contacting the first device 102.

For a different example, the sensing factor 204 can include touch, tactile, temperature, humidity, luminosity, or a combination thereof. For additional example, the sensing factor 204 can include presence of a number of people within the presentation context 206, movement of person/people, or a combination thereof. For further example, the sensing factor 204 can include elevation, pressure, biometric of a person, or a combination thereof.

The presentation context 206 is defined as a situation or environment surrounding the first device 102. For example, the presentation context 206 can represent indoor or outdoor. The first device 102 can include a lighting source 208. The lighting source 208 is defined as a device that emits a visible spectrum. The lighting source 208 can include halogen lamp, compact fluorescent lamp (CFL), light emitting diode (LED), or a combination thereof. More specifically as an example, the first device 102 can illuminate based on the lighting source 208 emitting light. The first device 102 can include multiple instances of the lighting source 208.

The first device 102 can have a device shape 210. The device shape 210 is defined as a contour of the first device 102. For example, the device shape 210 can include a cube, sphere, polygon, amorphous, flat bed, coaster, stick, tube, or combination thereof. The device shape 210 can form the appearance of the first device 102.

A device status 212 is defined as a state or condition of the first device 102. For example, the device status 212 can include a device relationship 214. The device relationship 214 is defined as an association between multiple devices. For example, the device relationship 214 can be formed between multiple instances of the first device 102, between the first device 102 and the second device 106, between multiple instances of the second device 106, or a combination thereof.

The device relationship 214 can include a master device 216 and a slave device 218. The master device 216 is defined as a device that leads other device(s). The slave device 218 is defined as a device that follows other device(s). For example, the master device 216 can control the function execution by the slave device 218. For another example, the slave device 218 can perform the function based on the function executed by the master device 216.

The electronic system 100 can detect a device presence 220 within the presentation context 206. The device presence 220 is defined as existence of a device. For example, by having the first device 102 within the presentation context 206, there is device presence 220 of the first device 102. The electronic system 100 can determine a device proximity 222. The device proximity 222 is a closeness or farness of devices from each other.

For example, the electronic system 100 can determine the device proximity 222 based on a device distance 224. The device distance 224 is defined as a physical distance between one device to another. For example, the device distance 224 can be one instance of the first device 102 and another instance of the first device 102. More specifically as an example, the device distance 224 can represent a minimum or maximum distance between the devices for the electronic system 100 to determine that the devices are within the device proximity 222. For further example, if the device distance 224 between one instance of the first device 102 and another instance of the first device 102 can be greater than the device distance 224 representing a maximum distance, the electronic system 100 can determine that the first device 102 is not within the presentation context 206.

A device contact 226 is defined as a situation where devices are touching each other. For example, one instance of the first device 102 can have the device contact 226 with another instance of the first device 102 by contacting at a surface point 228, along a device surface 230, or a combination thereof. The surface point 228 is defined as a physical spot on the device surface 230 of the first device 102. The device surface 230 is defined as an outer extent of the first device 102. For example, the device surface 230 can be made out of a material or materials that is transparent, translucent, or a combination thereof. For further example, the device surface 230 can be formed into the device shape 210 as discussed above to create the contour of the first device 102.

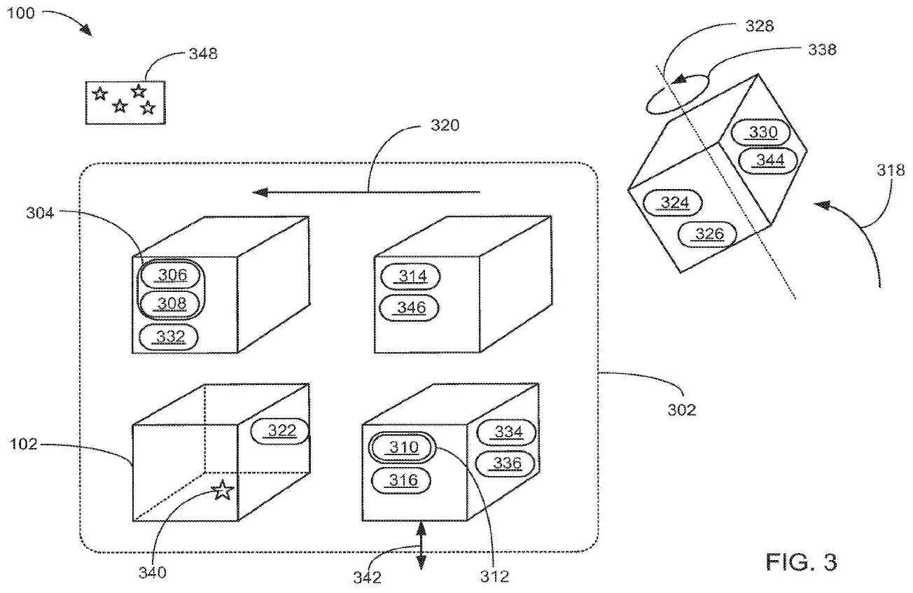

Referring now to FIG. 3, therein is shown a first example of a presentation ensemble 302 of multiple instances of the first device 102. The presentation ensemble 302 is defined as a grouping of multiple instances of a presentation arrangement 304. For example, the electronic system 100 can arrange the multiple instances of the presentation arrangement 304 as a group so that each instance of the presentation arrangement 304 is a part in relation to the group as a whole.

The presentation arrangement 304 is defined as a combination of a color arrangement 306, a luminosity level 308, or a combination thereof to be presented by a device. The color arrangement 306 is defined as a combination of a color 310 or multiple instances of the color 310. The luminosity level 308 is defined as lumen intensity or brightness of the color 310. The color 310 is defined as a quality of an object or substance with respect to light reflected by the object.

For further example, the lighting source 208 of FIG. 2 can emit the color 310 at various instance of the luminosity level 308 according to a color model 312. For example, the color model 312 can include RGB (red, green, and blue), HSL (hue, saturation, and lightness), HSV (hue, saturation, and value), or a combination thereof. Moreover, the lighting source 208 or multiple instances of the lighting source 208 of the first device 102 can adjust the RGB channel ratio of the color model 312 to blend various instances of the color 310 to generate the color arrangement 306.

For further example, the first device 102 can present the presentation arrangement 304 by presenting the color arrangement 306 at an instance of the luminosity level 308 with multiple instances of the lighting source 208. By emitting the color 310 or various combinations of multiple instances of the color 310, the first device 102 can generate a glowing effect by the color 310 emitted through, for example, the translucent material of the device surface 230 of the first device 102.

The electronic system 100 can present the presentation ensemble 302 as a pour effect 314, a wave effect 316, or a combination thereof. The pour effect 314 can include presenting multiple instances of the presentation arrangement 304 with multiple instances of the first device 102 where a gesture type 318 can cause a presentation direction 320 to illuminate in one direction. The wave effect 316 can include presenting multiple instances of the presentation arrangement 304 with multiple instances of the first device 102 where the gesture type 318 can cause the first device 102 to illuminate in random order.

The gesture type 318 is defined as action taken by the user of a device or on a device. For example, the gesture type 318 can include tilt, shake, throw, roll, tap, hold, palm, or a combination thereof. For a specific example, the user of the first device 102 can tap the device surface 230 of the first device 102 to trigger the lighting source 208 to emit the color 310.

The presentation direction 320 is defined as an order of illuminating the devices including the lighting source 208. For example, by the user tilting the master device 216 towards multiple instances of the slave device 218, the presentation direction 320 of triggering the slave device 218 to illuminate can start from the slave device 218 closest to the master device 216 and move on to the next instance of the slave device 218 second closest to the master device 216 to illuminate one instance or multiple instances of the lighting source 208. As a result, the slave device 218 furthest from the master device 216 can illuminate last. For further example, the presentation direction 320 can include left to right, right to left, top to bottom, bottom to top, one diagonal end to another diagonal end, or a combination thereof.

An effect level 322 is defined as an extent of the master device 216 influencing an instance or multiple instances of the slave device 218. The range of the effect level 322 can range from no effect to all instances of the devices present in the presentation context 206 of FIG. 2. Continuing with the example above, depending on an orientation change speed 324, an orientation change degree 326, or a combination thereof in a device orientation 328 caused by the gesture type 318, the effect level 322 on number of instances of the slave device 218 can differ.

The device orientation 328 is defined as a device's position in relation to cardinal coordinate. For example, when the user performing the gesture type 318 of holding the first device 102, the top extent of the first device 102 can point North East. The orientation change speed 324 is defined as a rate of change from one instance of the device orientation 328 to another instance of the device orientation 328. For example, the orientation change speed 324 can represent how fast the user is tilting the first device 102. The orientation change degree 326 is defined as an amount of angle change from one instance of the device orientation 328 to another instance of the device orientation 328. For example, the top extent of the first device 102 can point North initially. The user can tilt the first device 102 so that the top extent of the first device 102 can now point East. The orientation change degree 326 can represent 90 degrees.

Continuing with the example of the effect level 322 for example, the tilt of 10 degrees of the device orientation 328 of the master device 216 can cause the slave device 218 closest to illuminate while no other instance of the slave device 218 to illuminate. In contrast, the tilt of 90 degrees of the device orientation 328 of the master device 216 can cause more instances of the slave device 218 to illuminate than the tilt of only 10 degrees.

For further example, the effect level 322 can depend on an orientation threshold 330. The orientation threshold 330 is defined as limit placed on the change in the device orientation 328. For example, the orientation threshold 330 can represent maximum or minimum change to the device orientation 328. For further example, the electronic system 100 can compare the orientation change speed 324, the orientation change degree 326, or a combination thereof to the orientation threshold 330 to determine the effect level 322 on the first device 102.

A blend level 332 is defined as an extent of mixing multiple instances of the presentation arrangement 304. The blend level 332 can range from 0% mixing to 100% mixing. For a specific example, two instances of the first device 102 can be present in the presentation context 206. If the blend level 332 is 0%, the presentation arrangement 304 from each instance of the first device 102 is not mixed by one another. If the blend level is 50%, then each instance of the presentation arrangement 304 includes 50% from other instance of the presentation arrangement 304. If the blend level is 100%, then one of the presentation arrangement 304 includes 100% of other instance of the presentation arrangement 304 to create two instances of the same instance of the presentation arrangement 304.

A presentation duration 334 is defined as a time length of each emittance of the light with the color 310 by a device. For example, the presentation duration 334 can be represented in the time unit including nanosecond, microsecond, millisecond, second, minute, hour, day, week, month, year, season, or a combination thereof. A duration threshold 336 is defined as limit on the time length. For example, the duration threshold 336 can be represented in the time unit including nanosecond, microsecond, millisecond, second, or a combination thereof. The duration threshold 336 can represent minimum or maximum instance of the presentation duration 334.

A movement direction 338 can include a point of reference where a device is moving towards. For another example, the movement direction 338 can include a revolution direction of a device from spinning along the pitch axis, yaw axis, roll axis, or a combination thereof. For example, the first device 102 can have the movement direction 338 along the cardinal coordinate. A current location 340 is defined as the physical location of a device. For example, the current location 340 of the first device 102 can represent the first device 102 is placed on a table within the presentation context 206. A device altitude 342 is defined as a height or elevation of the device above sea level. For example, by stacking one instance of the first device 102 above another instance of the first device 102, the first device 102 on the top can have the device altitude 342 higher than the first device 102 on the bottom.

A movement count 344 can include the number of revolutions of the first device 102 spinning along the pitch axis, yaw axis, roll axis, or a combination thereof. For another example, the movement count 344 can include the number of ups and downs that the first device 102 experienced from change in the device altitude 342 caused by the gesture type 318 of the shake. A count threshold 346 is defined a limit on the movement count 344. For example, the count threshold 346 is defined as a maximum or minimum number of the movement count 344.

A presentation source 348 is defined as an origin of the presentation arrangement 304. For example, the presentation source 348 can include an image such as a photograph, an object, scenery, or a combination thereof.

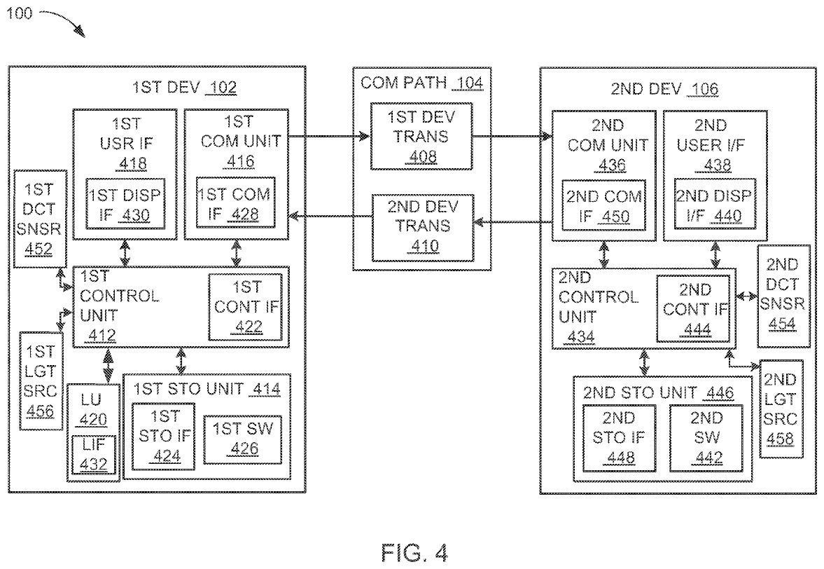

Referring now to FIG. 4, therein is shown an exemplary block diagram of the electronic system 100. The electronic system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 412, a first storage unit 414, a first communication unit 416, a first user interface 418, and a location unit 420. The first control unit 412 can include a first control interface 422. The first control unit 412 can execute a first software 426 to provide the intelligence of the electronic system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations physically separate from the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The location unit 420 can generate location information, current heading, and current speed of the first device 102, as examples. The location unit 420 can be implemented in many ways. For example, the location unit 420 can function as at least a part of a global positioning system (GPS), an inertial electronic system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the location unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations physically separate from the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, or any combination thereof to provide data and communication inputs.

The first user interface 418 can include a first display interface 430. The first display interface 430 can include a display, a projector, a video screen, a speaker, or any combination thereof.

The first control unit 412 can operate the first user interface 418 to display information generated by the electronic system 100. The first control unit 412 can also execute the first software 426 for the other functions of the electronic system 100, including receiving location information from the location unit 420. The first control unit 412 can further execute the first software 426 for interaction with the communication path 104 via the first communication unit 416.

The second device 106 can be optimized for implementing the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the electronic system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the electronic system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations physically separate from the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the electronic system 100 is shown with the second storage unit 446 as a single hierarchy storage system, although it is understood that the electronic system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations physically separate from the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The electronic system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100. For example, the first device 102 is described to operate the location unit 420, although it is understood that the second device 106 can also operate the location unit 420.

A first detecting sensor 452 can include accelerometer, magnetometer, gyroscope, compass, spectrum analyzer, beacon, altitude sensor, lighting sensor, magnetic sensor, thermometer, microphone, wireless signal receiver, remote physiological monitoring device, force meter, multi-axis sensor, or the combination thereof. For further example, the first detecting sensor 452 can include a digital camera, video camera, thermal camera, night vision camera, infrared camera, x-ray camera, or a combination thereof.

A second detecting sensor 454 can include accelerometer, magnetometer, gyroscope, compass, spectrum analyzer, beacon, altitude sensor, lighting sensor, magnetic sensor, thermometer, microphone, wireless signal receiver, remote physiological monitoring device, force meter, multi-axis sensor, or the combination thereof. For further example, the second detecting sensor 454 can include a digital camera, video camera, thermal camera, night vision camera, infrared camera, x-ray camera, or a combination thereof.

A first lighting source 456 can include halogen lamp, compact fluorescent lamp (CFL), light emitting diode (LED), or a combination thereof. A second lighting source 458 can include can include halogen lamp, compact fluorescent lamp (CFL), light emitting diode (LED), or a combination thereof. The first device 102 can include multiple instances (not shown) of the first lighting source 456. The second device 106 can include multiple instances (not shown) of the second lighting source 458.

The first control unit 412 can operate the first detecting sensor 452, the first lighting source 456, or a combination thereof. The second control unit 34 can operate the second detecting source 454, the second lighting source 458, or a combination thereof.

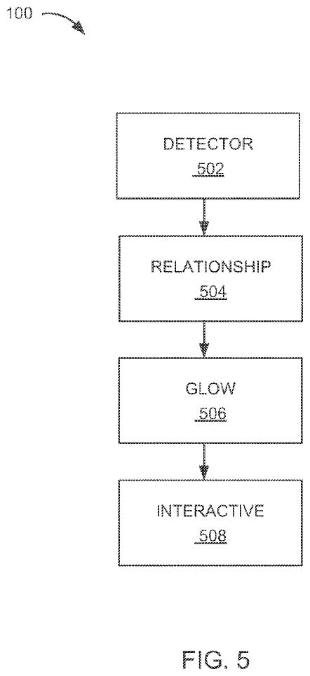

Referring now to FIG. 5, therein is shown a first control flow of the electronic system 100. The electronic system 100 can include modules to execute the presentation mechanism. The electronic system 100 can include a detector module 502. The detector module 502 detects the sensing factor 204 of FIG. 2. More specifically as an example, the detector module 502 can include, access to, or a combination thereof the detecting sensor 202 of FIG. 2, the location unit 420 of FIG. 4, or a combination thereof to detect the sensing factor 204. For a different example, the detector module 502 can include, access to, or a combination thereof multiple instances of the detecting sensor 202, the location unit 420, or a combination thereof to detect the sensing factor 204. The detecting sensor 202 can include the first detecting sensor 452 of FIG. 4, the second detecting sensor 454 of FIG. 4, or a combination thereof.

The detector module 502 can detect the sensing factor 204 in a number of ways. For example, the detector module 502 can detect the sensing factor 204 based on change in the device orientation 328 of FIG. 3, the movement direction 338 of FIG. 3, the current location 340, or a combination thereof. The sensing factor 204 can include rotation, speed, position, or a combination thereof of the first device 102. For a specific example, as the first device 102 changes the current location 340 by moving from one physical position to another, the detecting sensor 202 including an accelerometer, a gyroscope, or a combination thereof and the location unit 420, or a combination thereof can detect the sensing factor 204 of speed, position, or a combination thereof of the first device 102.

For further example, the detector module 502 can detect the sensing factor 204 for the gesture type 318 of FIG. 3. The detector module 502 can be preprogrammed to indicate certain instance or combination of instances of change in the device orientation 328, the movement direction 338, or a combination thereof can represent certain instance of the gesture type 318. For example, the detector module 502 can detect the gesture type 318 of shake if the first device 102 changes in the device altitude 342 of FIG. 3 with the movement direction 338 of up and down repetitively. For a different example, the detector module 502 can detect the gesture type 318 of tilt if the device orientation 328 of the first device 102 changes between 1 and 180 degrees along the pitch or roll axis.

More specifically as an example, the detector module 502 can detect the orientation change speed 324 of FIG. 3, the orientation change degree 326 of FIG. 3, or a combination thereof from the gesture type 318 causing the first device 102 to change the device orientation 328. For example, the detecting sensor 202 representing the accelerometer can detect the orientation change speed 324 of how fast the user is tilting the first device 102. For a different example, the detecting sensor 202 representing the gyroscope can detect the orientation change degree 326 of FIG. 3 for how much the user is tilting the first device 102.

For a different example, the detector module 502 can detect the sensing factor 204 detected on the surface point 228 of FIG. 2, the device surface 230 of FIG. 2, or a combination thereof of the first device 102. More specifically as an example, the sensing factor 204 can include sound, noise, vibration, or a combination thereof surrounding and/or contacting the first device 102. The detecting sensor 202 can include a microphone to detect and capture the sound, the noise, or a combination thereof surrounding the first device 102. For further example, the detecting sensor 202 can include the force meter to capture the vibration caused by the audible mechanical wave from the sound, the noise, or a combination thereof contacting the surface point 228, the device surface 230, or a combination thereof of the first device 102.

For another example, the sensing factor 204 can include touch, tactile, temperature, humidity, luminosity, or a combination thereof. The detecting sensor 202 can include a thermometer to detect the temperature within the presentation context 206 of FIG. 2. For further example, the detecting sensor 202 can include a lighting sensor to detect the change in the luminosity within the presentation context 206. For additional example, the detecting sensor 202 representing the force meter can detect the device contact 226 of FIG. 2 on the surface point 228, the device surface 230, or a combination thereof of the first device 102 made by touch, tactile, or a combination thereof.

For a different example, the sensing factor 204 can include presence of a number of people within the presentation context 206, movement of person/people, or a combination thereof. The detecting sensor 202 can include the infrared camera to detect the number of people present in the presentation context 206. For a different example, the detecting sensor 202 can include the digital camera, the video camera, or a combination thereof including the computer vision technology to track the movement of the person or people within the presentation context 206.

For additional example, the sensing factor 204 can further include elevation, pressure, biometric of a person, or a combination thereof. The detecting sensor 202 can include the altitude sensor to determine the change in the elevation of the first device 102. For a different example, the detecting sensor 202 can include the physiological monitoring device to track the biometric of a person.

For further example, the detector module 502 can detect the device presence 220 of FIG. 2 of the other instance of the first device 102 based on the sensing factor 204. More specifically as an example, the detector module 502 can detect the device presence 220 based on the sensing factor 204 representing magnetic field emitted by the first device 102. The detecting sensor 202 can include the magnetometer. Multiple instances of the first device 102 can be present in the presentation context 206. The detector module 502 can detect the device presence 220 of each instance of the first device 102 based on the detecting the sensing factor 204 representing the magnetic field emitted by each instance of the first device 102.

The above different instances of the sensing factor 204 can be detected by the detecting sensor 202, the location unit 420, or a combination thereof to be combined to generate the presentation arrangement 304 of FIG. 3 including the color arrangement 306 of FIG. 3, the luminosity level 308 of FIG. 3, or a combination thereof by the electronic system 100 discussed below. The detector module 502 can transmit the sensing factor 204 to a relationship module 504.

The electronic system 100 can include the relationship module 504, which can be coupled to the detector module 502. The relationship module 504 determines the device relationship 214 of FIG. 2 between one instance of the first device 102 and another instance of the first device 102.

The relationship module 504 can determine the device relationship 214 in a number of ways. For example, the relationship module 504 can determine the device relationship 214 between the master device 216 of FIG. 2 and the slave device 218 of FIG. 2 dynamically based on the sensing factor 204, the gesture type 318, or a combination thereof. More specifically as an example, the first device 102 representing the master device 216 initially can become the slave device 218 based on the sensing factor 204, the gesture type 318, or a combination thereof. For another example, the first device 102 representing the slave device 218 initially can become the slave device 218 based on the sensing factor 204, the gesture type 318, or a combination thereof.

For a specific example, the relationship module 504 can determine the first device 102 to become the master device 216 based on detecting the change in the current location 340 of the first device 102. By having the first device 102 move based on the gesture type 318 for example, the relationship module 504 can indicate the first device 102 that moved to become the master device 216. More specifically as an example, if multiple instances of the first device 102 move, each instance of the first device 102 can become the master device 216 while an instance or instances of the first device 102 that are stationary can represent the slave device 218.

For a further example, the gesture type 318 can represent a double tap on the device surface 230 of the first device 102 representing the slave device 218. The relationship module 504 can switch the slave device 218 into the master device 216 while changing the first device 102 that was originally the master device 216 into the slave device 218.

For another example, the sensing factor 204 can be an oral command. The oral command can be predefined. For example, the user can state “switch” as the oral command to the multiple instances of the first device 102. As a result, the relationship module 504 can update the slave device 218 as the master device 216 and the master device 216 as the slave device 218.

For additional example, the sensing factor 204 can represent a time of day. More specifically as an example, one instance of the first device 102 can represent the master device 216 during the hours of morning while another instance of the first device 102 can represent the master device 216 during the hours of evening. Depending on the time frame, the relationship module 504 can switch the master device 216 to become the slave device 218 or vice versa. The relationship module 504 can transmit the device relationship 214 to a glow module 506.

The electronic system 100 can include the glow module 506, which can be coupled to the detector module 502. The glow module 506 can generate the presentation arrangement 304 for presenting on or by the first device 102. The first device 102 can include multiple instances of the lighting source 208 of FIG. 2. The lighting source 208 can include the first lighting source 456 of FIG. 4, the second lighting source 458 of FIG. 4, or a combination thereof.

The glow module 506 can generate the presentation arrangement 304 in a number of ways. For example, the glow module 506 can generate the presentation arrangement 304 based on accessing multiple instances of the lighting source 208 to blend multiple instances of the color 310 emitted by each instance of the lighting source 208. For a different example, the multiple instances of the lighting source 208 can represent greater than one instance of the lighting source 208. For further example, the glow module 506 can generate the presentation arrangement 304 based on accessing each instance of the lighting source 208 from multiple instances of the first device 102.

For further example, the glow module 506 can generate the color arrangement 306 by controlling the color 310 emitted by each instance of the lighting source 208. More specifically as an example, if the glow module 506 is to generate the color arrangement 306, the glow module 506 can control the color 310 to be emitted from each instance the lighting source 208 within the first device 102 to blend multiple instances of the color 310 from each of the lighting source 208 based on the color model 312 such as the RGB color model.

For a further example, the glow module 506 can generate the presentation ensemble 302 of FIG. 3 by adjusting the multiple instances of the presentation arrangement 304 from multiple instances of the first device 102. Each instance of the first device 102 can communicate with each other via the communication path 104. More specifically as an example, the glow module 506 of each instance of the first device 102 can transmit the presentation arrangement 304 to share with other instance of the first device 102. For a different example, the glow module 506 of the first device 102 and the glow module 506 of the second device 106 of FIG. 1 can transmit the presentation arrangement 304 to share with each other. The presentation ensemble 302 can represent a combination of multiple instances of the presentation arrangement 304 with multiple instance of the first device 102.

For a specific example, two instances of the first device 102 can represent the master device 216. Remaining instances of the first device 102 can represent the slave device 218. An order to change the presentation arrangement 304 for each instance of the slave device 218 can be preset or in random. By changing the device orientation 328 of each instance of the master device 216 along the axis for pitch, yaw, roll, or a combination thereof, the glow module 506 can blend two instances of the presentation arrangement 304 according to the RGB channel ratios of the color model 312 for presenting the blended instance of the presentation arrangement 304 on each instance of the slave device 218.

For additional example, three instances of the first device 102 can represent the master device 216 while the fourth instance of the first device 102 can represent the slave device 218. Based on the change in the device orientation 328 for each of the master device 216 as discussed above, the glow module 506 can blend three instances of the presentation arrangement 304 according to the RGB channel ratios of the color model 312 for presenting the blended instance of the presentation arrangement 304 on the fourth instance of the slave device 218. For this example, each instance of the master device 216 can present the presentation arrangement 304 with the color 310 of Red, Green, and Blue respectively when stationary while the slave device 218 can present the presentation arrangement 304 with the color 310 of White at rest.

It has been discovered that the electronic system 100 presenting blended instance of the presentation arrangement 304 on the slave device 218 based on blending multiple instances of the presentation arrangement 304 improves the efficiency of presenting the color arrangement 306, the luminosity level 308, or a combination thereof on different devices. By transmitting and determining each instance of the presentation arrangement 304 from each instance of the master device 216, the electronic system 100 or the slave device 218 can generate blended instance of the presentation arrangement 304 efficiently.

For a different example, the glow module 506 can generate the presentation arrangement 304 based on the color model 312, the sensing factor 204, the gesture type 318, or a combination thereof. For a specific example, the gesture type 318 can represent the shake. The shake can represent the change in the device altitude 342 of the first device having the movement direction 338 of up and down. More specifically as an example, the glow module 506 can generate the presentation arrangement 304 based on determining the color 310 according to the movement count 344 of FIG. 3 of the movement direction 338 meeting or exceeding the count threshold 346 of FIG. 3. The presentation arrangement 304 to be displayed by the first device 102 can be pre-fixed to a specific instance of the color 310 or dynamically adjusted to change the color 310 according to the sensing factor 204 detected.

For a specific example, the gesture type 318 of shake can result in the movement count 344 of 1 for the movement direction 338 of up and down for the change in the device altitude 342 by the first device 102. The glow module 506 can track the movement direction 338 of up and down as one set to count as the movement count 344 of 1. The glow module 506 can generate the presentation arrangement 304 including the color 310 of yellow if the movement count 344 is less than the count threshold 346. In contrast, if the movement count 344 meets or exceeds the count threshold 346, the glow module 506 can generate the presentation arrangement 304 to include the color 310 of purple.

For another example, the glow module 506 can generate the presentation arrangement 304 based on the gesture type 318, the device orientation 328, the color model 312, or a combination thereof. More specifically as an example, the device orientation 328 of the first device 102 can be changed according to changes in the pitch, yaw, roll, or a combination thereof of the first device 102 caused by the gesture type 318. For a specific example, the first device 102 can have a pitch rotation, yaw rotation, roll rotation, or a combination thereof.

For example, based on the change in the device orientation 328 meeting or exceeding the orientation threshold 330 of FIG. 3 ranging from 1 to 360 degrees, the glow module 506 can update the presentation arrangement 304 according to the color model 312, the luminosity level 308, or a combination thereof. More specifically as an example, the glow module 506 can update the presentation arrangement 304 based on the change in each degree of the device orientation 328. For another example, the glow module 506 can update the presentation arrangement 304 based on each full yaw rotation of the first device 102 by changing the color arrangement 306 from blue to red after rotating 360 degrees or after each full revolution.

For a different example, the glow module 506 can set multiple instances of the orientation threshold 330. More specifically as an example, as the device orientation 328 meets or exceeds each instance of the orientation threshold 330 due to a movement of the first device 102, the glow module 506 can update the presentation arrangement 304 by changing the color 310, the luminosity level 308, or a combination thereof. For a specific example, the luminosity level 308 of the orientation change degree 326 less than the orientation threshold 330 of 60 degrees can be dimmer than the luminosity level 308 of the orientation change degree 326 less than the orientation threshold 330 of 120 degrees.

For another example, if the orientation change degree 326 meets or exceeds the orientation threshold 330 of 60 degrees but less than the orientation threshold 330 of 120 degrees, the glow module 506 can update the presentation arrangement 304 to include the color 310 of Magenta. In contrast, if the orientation change degree 326 meets or exceeds the orientation threshold 330 of 120 degrees but less than the orientation threshold 330 of 180 degrees, the glow module 506 can update the presentation arrangement 304 to include the color 310 of Turquois.

For a different example, the glow module 506 can determine the presentation arrangement 304 based on the device altitude 342, the sensing factor 204, or a combination thereof. More specifically as an example, multiple instances of the first device 102 can be piled or stacked on top of each other. Based on the level of stack, the device altitude 342 for each instance of the first device 102 can differ. The glow module 506 for each of the first device 102 can determine the device altitude 342 relative to each other by sharing the device altitude 342, the current location 340, or a combination thereof. As a result, the glow module 506 can determine the color arrangement 306, the luminosity level 308, or a combination thereof according to the change in the device altitude 342. For additional example, the glow module 506 can generate the presentation ensemble 302 based on the multiple instances of the first device 102 arranged to have the device contact 226 of FIG. 2 on the top, bottom, side, adjacent, or a combination thereof of each instance of the first device 102.

For a further example, the glow module 506 can determine the presentation arrangement 304 based on the sensing factor 204 representing the device contact 226. More specifically as an example, the device contact 226 can represent one instance of the first device 102 physically contacting another instance of the first device 102. The device contact 226 can be established at the surface point 228, the device surface 230, or a combination thereof at an outer extent of the first device 102.

For a specific example, the glow module 506 can determine the presentation arrangement 304 based on the device altitude 342, the device contact 226, or a combination thereof. For example, one instance of the first device 102 can be stacked on top of another instance of the first device 102. With each instance of the first device 102 stacked on top of another instance of the first device 102, the glow module 506 can change the luminosity level 308 of the first device 102 to be brighter or dimmer than the luminosity level 308 of the first device 102 that is below.

For another example, the glow module 506 can generate the presentation ensemble 302 based on mixing or blending multiple instances of the presentation arrangement 304. More specifically as an example, multiple instances of the presentation arrangement 304 can be blended to generate the pour effect 314 of FIG. 3, the wave effect 316 of FIG. 3, or a combination thereof. The pour effect 314, the wave effect 316, or a combination thereof can include changes in the color arrangement 306, the luminosity level 308, or a combination thereof from the master device 216 of FIG. 2 to the slave device 218 of FIG. 2.

The glow module 506 can mix multiple instances of the color arrangement 306 into one instance of the color arrangement 306 based on the sensing factor 204. The glow module 506 can mix multiple instances of the luminosity level 308 into one instance of the luminosity level 308 based on the sensing factor 204.

For a specific example, the electronic system 100 can include multiple instances of the first device 102 representing the master device 216. For a further example, the electronic system 100 can include multiple instances of the first device 102 representing the slave device 218. The multiple instances of the slave device 218 can be lined up.

The glow module 506 can generate the pour effect 314 by changing the device orientation 328 of each instance of the master device 216 with the gesture type 318 of tilt to mix the color arrangement 306, the luminosity level 308, or a combination thereof to the slave device 218. The gesture type 318 of tilt can change the device orientation 328 from 1 to 180 degrees by rotating along the pitch or roll axis. Each instance of the master device 216 can include different instance of the color arrangement 306. For example, one instance of the master device 216 can present the color 310 of Red and another instance of the master device 216 can present the color 310 of Green.

As discussed above, one instance of the first device 102 can communicate to another instance of the first device 102. Continuing with the example, each instance of the master device 216 can transmit the color 310, the device orientation 328, or a combination thereof to the slave device 218. As a result, by having the device orientation 328 of each instance of the master device 216 tilted towards the slave device 218, the glow module 506 can generate the color arrangement 306 representing the color 310 of Brown to be displayed on the slave device 218 by mixing the color 310 of Red and Green.

For further example, if one instance of the master device 216 can tilt more by having orientation change degree 326 greater than the orientation change degree 326 of another instance of the master device 216, the color 310 from the master device 216 with greater tilt can be presented more in the color arrangement 306 of the slave device 218. More specifically as an example, if the master device 216 with the color 310 of Red is tilted more, the glow module 506 can generate the color arrangement 306 including the color 310 that is more Reddish Brown presented by the slave device 218.

The glow module 506 can generate the pour effect 314 by mixing different instances of the color arrangement 306 according to the color model 312 as discussed above. Furthermore, based on the orientation change speed 324, the orientation change degree 326, the movement direction 338 for the change of the device orientation 328 of the master device 216, the effect level 322 of FIG. 3 of the pour effect 314 can differ. The master device 216 can control the effect level 322, the presentation direction 320 of FIG. 3, or a combination thereof based on the change in the device orientation 328 of the master device 216.

More specifically as an example, if the orientation change speed 324 is less than the orientation threshold 330, the effect level 322 of the pour effect 314 can reach the first instance of the slave device 218. For a different example, if the orientation change speed 324 exceeds the orientation threshold 330, the effect level 322 of the pour effect 314 can reach the last instance of the slave device 218 lined up in the line of multiple instances of the slave device 218.

For a further example, the glow module 506 can change the luminosity level 308 based on the orientation change degree 326 of tilt. As discussed above, if the change in the orientation change degree 326 due to the tilt is less than the orientation threshold 330, the luminosity level 308 displayed on the slave device 218 can be less than the luminosity level 308 of when the orientation change degree 326 is equal to or greater than the orientation threshold 330. The glow module 506 can change the luminosity level 308 accordingly at each change of tilt degree represented as the orientation change degree 326 of the device orientation 328.

For a further example, the pour effect 314 can result in the multiple instances of the slave device 218 changing the presentation arrangement 304 according to the presentation direction 320 of FIG. 3. For example, the presentation direction 320 can represent from left to right, right to left, top to bottom, bottom to top, one diagonal end to another diagonal end, or a combination thereof. The presentation direction 320 can represent change in the color arrangement 306, the luminosity level 308, or a combination thereof in a direction along one extent of the cardinal coordinate to another extent of the cardinal coordinate.

The glow module 506 can generate the wave effect 316. One instance of the first device 102 can represent the master device 216. Other instances of the first device 102 can represent the slave device 218. The glow module 506 can generate the wave effect 316 by presenting the presentation arrangement 304 on each instance of the slave device 218 in random order based on the change in the device orientation 328 of the master device 216.

More specifically as an example, the master device 216 can control the presentation of the presentation arrangement 304 of the slave device 218 based on the change in the device orientation 328. For example, based on the change of the device orientation 328 along the pitch axis, the glow module 506 can change the color arrangement 306 of the slave device 218. Based on the change of the device orientation 328 along the roll axis, the glow module 506 can change the luminosity level 308 or determine which instance of the slave device 218 to present the presentation arrangement 304.

The glow module 506 can generate the wave effect 316 so that each instance of the slave device 218 can present the presentation arrangement 304 at a different time frame. More specifically as an example, each instance of the slave device 218 can present the presentation arrangement 304 with a time delay so that the subsequent instance of the slave device 218 will not present the presentation arrangement 304 unless the previous instance of the slave device 218 completes presenting the presentation arrangement 304. For further example, the glow module 506 can control the presentation duration 334 of FIG. 3 for each instance of the first device 102 by turning on or off the presentation arrangement 304. For example, the glow module 506 can allow the master device 216 to set the color arrangement 306, the luminosity level 308, or a combination thereof of the slave device 218.

It has been discovered that the electronic system 100 generating the presentation arrangement 304 based on the gesture type 318, the device orientation 328, or a combination thereof improves the accuracy of adjusting the presentation arrangement 304. By granularly controlling the degree of adjustment of the presentation arrangement 304 based on the device orientation 328, the electronic system 100 can blend the color arrangement 306, the luminosity level 308, or a combination thereof. As a result, the electronic system 100 can improve the accuracy of determining the presentation arrangement 304 desired for enhanced user experience using the first device 102, the electronic system 100, or a combination thereof.

For a different example, the glow module 506 can update the presentation arrangement 304 based on the device orientation 328 changed by the first device 102 spinning along the axis of the pitch, yaw, roll, or a combination thereof of the first device 102. For example, the first device 102 can spin along multiple axes by changing the device orientation 328 from 360 degrees and above. If there are multiple instances of the slave device 218, the glow module 506 can change the presentation arrangement 304 of each instance of the slave device 218 based on the spin of the master device 216.

More specifically as an example, the color arrangement 306 of the master device 216 can be the color 310 of Red. After the master device 216 completes a full rotation, the glow module 506 can update the color arrangement 306 of the slave device 218 to represent the color 310 of Red. Moreover, after the first instance of the slave device 218 completes a full rotation, the glow module 506 can update the color arrangement 306 of the second instance of the slave device 218 to represent the color 310 of Red to show the traveling of the color 310 from one instance of the first device 102 to another instance of the first device 102.

For another example, the glow module 506 can generate the presentation arrangement 304 based on blending the color arrangement 306, the luminosity level 308, or a combination thereof. More specifically as an example, as discussed above, the first device 102 can include multiple instances of the lighting source 208. For a specific example, the number of the lighting source 208 can represent four. Each instance of the lighting source 208 can present different instance of the color arrangement 306, the luminosity level 308, or a combination thereof from one another.

For a further example, the glow module 506 can determine the presentation arrangement 304 based on the presentation context 206, the presentation source 348 of FIG. 3, the sensing factor 204, or a combination thereof. For example, the presentation source 348 can represent an image of a sunset. Based on image recognition algorithm, computer vision technology, or a combination thereof, the glow module 506 can adjust the color arrangement 306, the luminosity level 308, or a combination thereof of each instance of the lighting source 208 to blend the color 310 to generate the presentation arrangement 304 representing shades of the color 310 of the sunset. More specifically as an example, the glow module 506 can adjust the color arrangement 306 by controlling the hue, saturation, lightness, value, or a combination thereof of the color model 312 emitted by each instance of the lighting source 208 to blend the color arrangement 306 to represent the sunset as presented in the presentation source 348.

For a different example, the presentation context 206 can represent an environment surrounding the first device 102. More specifically as an example, the presentation context 206 can represent sunrise at a beach. Based on detecting the color 310 surrounding the first device 102 within the presentation context 206, the glow module 506 can adjust the color arrangement 306, the luminosity level 308, or a combination thereof of each instance of the lighting source 208 to blend the color 310 to generate the presentation arrangement 304 representing the color 310 shade of the sunrise similarly to as discussed for generating the color arrangement 306 for the sunset.

It has been discovered that the electronic system 100 generating the presentation arrangement 304 based on adjusting the color arrangement 306, the luminosity level 308, or a combination thereof from each instance of the lighting source 208 improves the accuracy of presentation arrangement 304. By controlling the output of each instance of the lighting source 208, the electronic system 100 can accurate capture the color 310 presented by the presentation context 206, the presentation source 348, or a combination thereof. As a result, the electronic system 100 can improve the user experience using the first device 102, the electronic system 100, or a combination thereof.

For another example, the glow module 506 can blend the presentation arrangement 304 based on the device proximity 222 of FIG. 2 between multiple instances of the first device 102. Each instance of the first device 102 can include the detecting sensor 202 representing the magnetic sensor. Based on accessing the magnetic sensor detecting the presence of the first device 102, the glow module 506 can determine the device proximity 222 including the device distance 224 of FIG. 2 between each instance of the first device 102.

For example, the glow module 506 can adjust the blend level 332 of FIG. 3 of the presentation arrangement 304 based on the sensing factor 204. More specifically as an example, the glow module 506 can adjust the blend level 332 of the presentation arrangement 304 based on the device proximity 222. For a specific example, the glow module 506 can adjust the blend level 332 based on the change in the device distance 224 between one instance of the first device 102 to another instance of the first device 102. The glow module 506 can adjust the blend level 332 by changing the color arrangement 306, the luminosity level 308, or a combination thereof from each instance of the lighting source 208 based on the device proximity 222 of multiple instances of the first device 102.

More specifically as an example, two instances of the first device 102 can be present in the presentation context 206. Each instance of the first device 102 can present different instance of the color arrangement 306 from each other. For example, one instance of the first device 102 can present the color arrangement 306 including the color 310 of Blue. Another instance of the first device 102 can present the color arrangement 306 including the color 310 of Red.

Continuing with the example, as the device distance 224 between the two instances of the first device 102 decreases, the glow module 506 can adjust the blend level 332 for each instance of the first device 102. More specifically as an example, the first device 102 presenting the color arrangement 306 of Blue can blend more instance of the color 310 of Red while the first device 102 presenting the color arrangement 306 of Red can blend more instance of the color 310 of Blue. If the two instances of the first device 102 are adjacent to each other by having the device contact 226 along the device surface 230 of each instance of the first device 102, the glow module 506 can adjust the blend level 332 to generate the color arrangement 306 of Purple by combining the color 310 of Blue and Red.

Continuing with the example, as the device distance 224 between the two instances of the first device 102 increases in the device distance 224, the glow module 506 can update the blend level 332. More specifically as an example, the first device 102 presenting the color arrangement 306 of Blue can blend less instance of the color 310 of Red while the first device 102 presenting the color arrangement 306 of Red can blend less instance of the color 310 of Blue. At certain instance of the device distance 224, each instance of the first device 102 can present the color arrangement 306 including the original instance of the color 310 prior to blending different instances of the color 310.

For a different example, the glow module 506 can change the presentation arrangement 304 based on detecting the sensing factor 204 representing the bump between multiple instances of the first device 102. The bump can represent the device contact 226 between multiple instances of the first device 102 on the surface or outer extent of the first device 102 at a force (newton) for a time period. The force can represent greater than zero newton and the time period can a time greater than zero.

Based on the device contact 226 from the bump, the glow module 506 can generate the presentation arrangement 304 of the flash. The flash can represent a light emission including the color arrangement 306, the luminosity level 308, or a combination thereof for the presentation duration 334 meeting or below the duration threshold 336 of FIG. 3. The glow module 506 can generate the flash repeatedly to continuously emit the presentation arrangement 304 including the flash.

For a different example, the glow module 506 can update the presentation arrangement 304 after detecting the bump. More specifically as an example, with each instance of the device contact 226 form the bump, the glow module 506 can change the luminosity level 308 by increasing or decreasing the brightness of the color arrangement 306.

For another example, the glow module 506 can generate the presentation arrangement 304 based on the sensing factor 204 representing the audible mechanical wave. More specifically as an example, the audible mechanical wave can represent the sound from the music. The music can include beat, tempo, melody, or a combination thereof. Based on the beat, tempo, melody, or a combination thereof, the glow module 506 can adjust the presentation arrangement 304 by changing the color arrangement 306, the luminosity level 308, or a combination thereof displayed on the first device 102.

For a further example, the glow module 506 can adjust the presentation ensemble 302 by changing the presentation arrangement 304 from each instance of the first device 102 out of multiple instances of the first device 102. More specifically as an example, the glow module 506 can update the color arrangement 306 by changing the color 310 with each beat of the music. For a different example, the glow module 506 can update the luminosity level 308 by changing the brightness of the color arrangement 306 with each beat of the music. The glow module 506 can transmit the presentation arrangement 304 to an interactive module 508.

The electronic system 100 can include the interactive module 508, which can be coupled to the glow module 506. The interactive module 508 shares the information regarding the first device 102. For example, the interactive module 508 can share the device status 212 to various types of the first device 102. Each instance of the first device 102 can represent a mobile communication device, a mobile entertainment device, or a combination thereof.

The interactive module 508 can share the device status 212 in a number of ways. For example, the interactive module 508 can share the device status 212 including the device relationship 214 to each instance of the first device 102 including the mobile communication device, the mobile entertainment device, or a combination thereof. More specifically as an example, the interactive module 508 can share the device status 212 indicating which instance of the first device 102 can represent the master device 216 or the slave device 218.

For a different example, the interactive module 508 can share the device status 212 including various combination of the presentation arrangement 304 discussed above to each instance of the first device 102 including the mobile communication device, the mobile entertainment device, or a combination thereof. More specifically as an example, the interactive module 508 can share the color arrangement 306 to the mobile communication device, the mobile entertainment device, or a combination thereof to indicate the color 310, the blend level 332, or a combination thereof emitted by the mobile entertainment device.

For another example, the interactive module 508 can share the device status 212 including each of the sensing factor 204 or a combination thereof detected to each instance of the first device 102 including the mobile communication device, the mobile entertainment device, or a combination thereof. More specifically as an example, the interactive module 508 can share the device orientation 328, the movement direction 338, or a combination thereof of one instance of the first device 102 to another instance of the first device 102.

For further example, the interactive module 508 can synchronize the device relationship 214, the presentation arrangement 304, the sensing factor 204, or a combination thereof with each instance of the first device 102 including the mobile communication device, the mobile entertainment device, or a combination thereof. More specifically as an example, the interactive module 508 can synchronize the presentation arrangement 304 between multiple instances of the first device 102 to present the same instance of the color arrangement 306.

For a different example, each instance of the first device 102 can present different instance of the presentation arrangement 304. The interactive module 508 can synchronize the different instances of the presentation arrangement 304 from each instance of the first device 102 for the generation of the presentation ensemble 302. More specifically as an example, the presentation source 348 can represent an image of sunset. By having the different instances of the presentation arrangement 304 synchronized, the glow module 506, as discussed above, can determine the presentation arrangement 304 for which instance of the first device 102 represents a part of the sunset image.

The physical transformation from movement of the first device 102 by changing the device orientation 328 results in the movement in the physical world, such as people using the first device 102, the presentation arrangement 304 displayed, or a combination thereof, based on the operation of the electronic system 100. As the movement in the physical world occurs, the movement itself creates additional information that is converted back into updating the presentation arrangement 304, generating the presentation ensemble 302, or a combination thereof for the continued operation of the electronic system 100 and to continue the movement in the physical world.

The first software 426 of FIG. 4 of the first device 102 of FIG. 4 can include the modules for the electronic system 100. For example, the first software 426 can include the detector module 502, the relationship module 504, the glow module 506, and the interactive module 508. The first control unit 412 of FIG. 4 can execute the first software 426 dynamically and in real time.

The first control unit 412 can execute the first software 426 for the detector module to detect the sensing factor 204. The first control unit 412 can execute the first software 426 for the relationship module 504 to determine the device relationship 214. The first control unit 412 can execute the first software 426 for the glow module 506 to generate the presentation arrangement 304. The first control unit 412 can execute the first software 426 for the interactive module 508 to share the device status 212, the presentation arrangement 304, the sensing factor 204, or a combination thereof.

The second software 442 of FIG. 4 of the second device 106 of FIG. 4 can include the modules for the electronic system 100. For example, the second software 442 can include the detector module 502, the relationship module 504, the glow module 506, and the interactive module 508. The second control unit 434 of FIG. 4 can execute the second software 442 dynamically and in real time.

The second control unit 434 can execute the second software 442 for the detector module to detect the sensing factor 204. The second control unit 434 can execute the second software 442 for the relationship module 504 to determine the device relationship 214. The second control unit 434 can execute the second software 442 for the glow module 506 to generate the presentation arrangement 304. The second control unit 434 can execute the second software 442 for the interactive module 508 to share the device status 212, the presentation arrangement 304, the sensing factor 204, or a combination thereof.

The modules of the electronic system 100 can be partitioned between the first software 426 and the second software 442. The second software 442 can include the relationship module 504 and the interactive module 508. The second control unit 434 can execute modules partitioned on the second software 442 as previously described.

The first software 426 can include the detector module 502 and the glow module 506. Based on the size of the first storage unit 414, the first software 426 can include additional modules of the electronic system 100. The first control unit 412 can execute the modules partitioned on the first software 426 as previously described.

The first control unit 412 can operate the first communication unit 416 of FIG. 4 to communicate the sensing factor 204, the presentation arrangement 304, the device relationship 214, or a combination thereof to or from the second device 106 through the communication path 104. The first control unit 412 can operate the first software 426 to operate the location unit 420. The second control unit 434 can operate the second communication unit 436 to communicate the sensing factor 204, the presentation arrangement 304, the device relationship 214, or a combination thereof to or from the first device 102 through the communication path 104.

The electronic system 100 describes the module functions or order as an example. The modules can be partitioned differently. For example, the detector module 502 and the glow module 506 can be combined. Each of the modules can operate individually and independently of the other modules. Furthermore, data generated in one module can be used by another module without being directly coupled to each other. For example, the one module can receive the sensing factor 204 from another module. Further, “communicating” or “transmitting” can include sending, receiving, or a combination thereof the data generated to or from one to another.

The modules described in this application can be hardware implementation or hardware accelerators in the first control unit 412 or in the second control unit 434. The modules can also be hardware implementation or hardware accelerators within the first device 102 or the second device 106 but outside of the first control unit 412 or the second control unit 434, respectively. The modules described in this application can be hardware implementation or hardware accelerators in the first control unit 412 or in the second control unit 434.

The modules can also be hardware implementation or hardware accelerators within the first device 102 or the second device 106 but outside of the first control unit 412 or the second control unit 434, respectively as depicted in FIG. 4. However, it is understood that the first control unit 412, the second control unit 434, or a combination thereof can collectively refer to all hardware accelerators for the modules. Furthermore, the first control unit 412, the second control unit 434, or a combination thereof can be implemented as software, hardware, or a combination thereof.

The modules described in this application can be implemented as instructions stored on a non-transitory computer readable medium to be executed by the first control unit 412, the second control unit 434, or a combination thereof. The non-transitory computer medium can include the first storage unit 414 of FIG. 4, the second storage unit 446 of FIG. 4, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the electronic system 100 or installed as a removable portion of the electronic system 100.

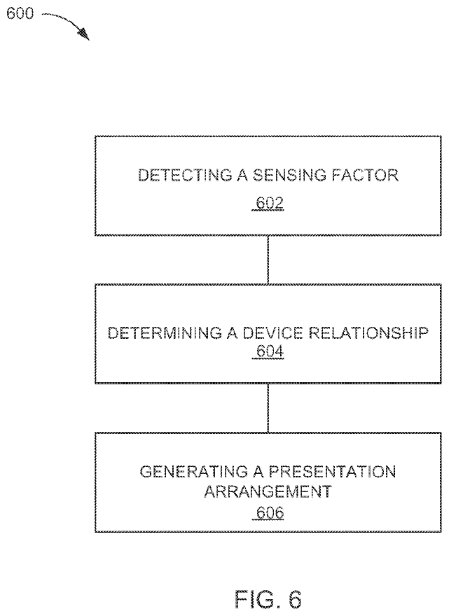

Referring now to FIG. 6, therein is shown a flow chart of a method 600 of operation of the electronic system 100 in a further embodiment of the present invention. The method 600 includes: detecting a sensing factor within a presentation context in a block 602; determining a device relationship based on the sensing factor for establishing the device relationship between multiple instances of a device in block 604; and generating a presentation arrangement with a control unit for presenting a color arrangement at a luminosity level according to the device relationship for presenting on the device in a block 606.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

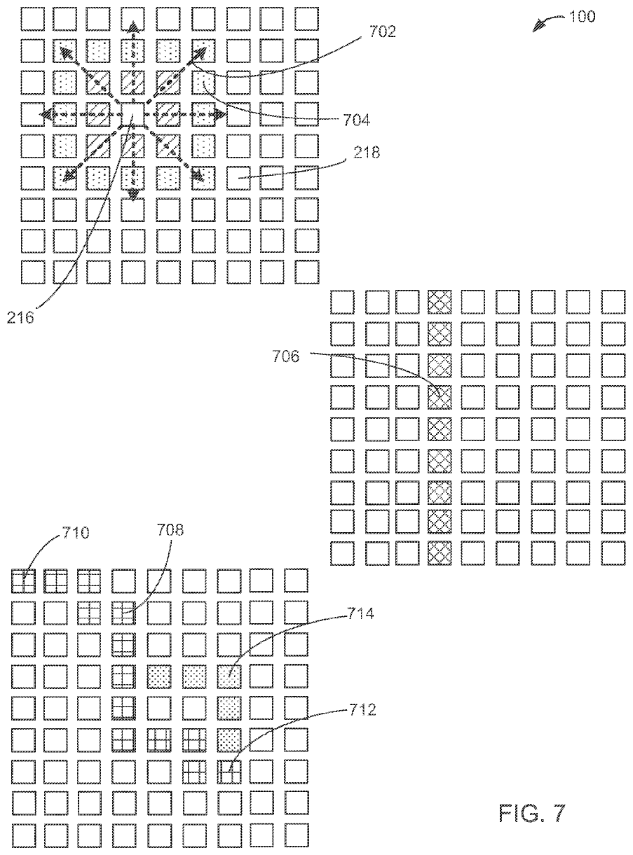

Referring now to FIG. 7, therein is shown a second example of the presentation ensemble 302 of FIG. 3 of multiple instances of the first device 102 of FIG. 1. A ripple effect 702 can include presenting multiple instances of the presentation arrangement 304 of FIG. 3 by multiple instances of the slave device 218 where the gesture type 318 of FIG. 3 to the master device 216 can cause the presentation direction 320 of FIG. 3 to illuminate in multiple directions. For a specific example, the master device 216 can locate in the center, the side, the extent, above, the bottom, in the corner, or a combination thereof.

More specifically as an example, the master device 216 can be surrounded by the multiple instances of the slave device 218. For further example, similar to a ripple in a body of water, the presentation arrangement 304 having the ripple effect 702 can be presented in the presentation direction 320 originating from the master device 216 in the center. For another example, the presentation arrangement 304 having the ripple effect 702 can be presented in the presentation direction 320 originating from the master device 216 located in the location different from the center surrounded by multiple instances of the first device 102. The presentation direction 320 can spread from the master device 216 to multiple instances of the slave device 218 similar to a ripple.

A presentation boundary 704 is defined as multiple instances of the first device 102 surrounding the first device 102. For example, the presentation boundary 704 can surround the first device 102 in the center 360 degrees of cardinal direction. For example, the presentation boundary 704 can surround the first device 102 less than 360 degrees in cardinal direction, thus, not surrounding the master device 216 completely and leaving a cardinal direction without the slave device 218 receiving the ripple effect 702. The presentation boundary 704 can represent the arrangement of multiple instances of the first device 102. The shape of the presentation boundary 704 can include a polygon, circle, amorphous shape, or a combination thereof. As discussed above, multiple instances of the slave device 218 can surround the master device 216 forming the presentation boundary 704. One instance of the presentation boundary 704 can be surrounded by another instance of the presentation boundary 704 that is larger creating layers of the presentation boundary 704 surrounding the master device 216.

For example, multiple instances of the first device 102 can be physically laid out in 7 by 7 rows and columns. For a different example, multiple instances of the first device 102 can be physically laid out in 10 by 10 rows and columns. For a different example, multiple instances of the first device 102 can be physically laid out in 9 by 9 rows and columns. For further example, the ripple effect 702 can include presenting the presentation arrangement 304 of each instance of the presentation boundary 704 independently or multiple instances of the presentation boundary 704 having different instances of the color arrangement 306 of FIG. 3, the luminosity level 308 of FIG. 3, or a combination thereof simultaneously or at the same time.

A line effect 706 can include presenting multiple instances of the presentation arrangement 304 with multiple instances of the slave device 218 where the gesture type 318 to the master device 216 can cause a row of or a column of multiple instances of the slave device 218 to illuminate. For example, multiple instances of the first device 102 can be physically laid out in 9 by 9 rows and columns. More specifically as an example, each row of multiple instances of the first device 102 can include 9 devices of the first device 102. Similarly, each column of multiple instances of the first device 102 can include 9 devices of the first device 102.

For example, the line effect 706 can include a row of multiple instances of the first device 102 presenting the presentation arrangement 304 simultaneously or at the same time. For another example, the line effect 706 can include a column of multiple instances of the first device 102 presenting the presentation arrangement 304 simultaneously or at the same time. For further example, the line effect 706 can include presenting the presentation arrangement 304 of each row independently or presenting the presentation arrangement 304 of multiple rows simultaneously or at the same time. For a different example, the line effect 706 can include presenting the presentation arrangement 304 of each column independently or presenting the presentation arrangement 304 of multiple columns simultaneously or at the same time.

For additional example, the ripple effect 704, the line effect 706, or a combination thereof and the wave effect 316 of FIG. 3 can be combined. More specifically as an example, each or combination of rows and columns of the presentation arrangement 304 can be presented in order of in random order. The presentation ensemble 302 can include and be presented having the pour effect 314 of FIG. 3, the wave effect 316, the ripple effect 702, the line effect 706, or a combination thereof.

A presentation path 708 is defined as a passage determined by the electronic system 100 to transmit the presentation arrangement 304 from an origin device 710 to a target device 712. The origin device 710 is defined as where the presentation path 708 starts. The target device 712 is defined as where the presentation path 708 ends.

For example, the presentation path 708 can represent an order of presenting the presentation arrangement 304 for each instance of the first device 102 until reaching the target device 712. For further example, the origin device 710 can represent the master device 216 of FIG. 2. The target device 712 can represent the slave device 218 of FIG. 2. For another example, the presentation path 708 can be the passage created by multiple number of the first device 102 in between the origin device 710 and the target device 712.

The presentation path 708 can include a shortest path 714. The shortest path 714 can represent the presentation path 708 where a number of the first device 102 between the origin device 710 and the target device 712 can be the least.

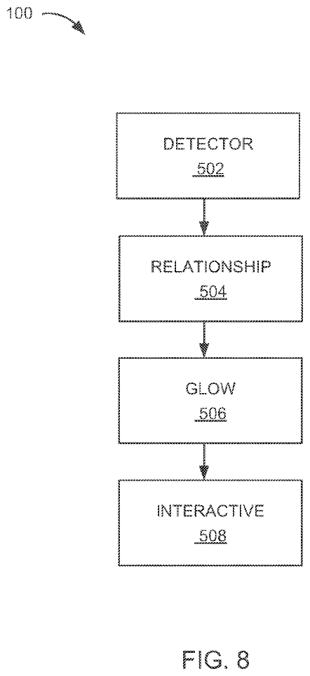

Referring now to FIG. 8, therein is shown a second control flow of the electronic system 100. The second control flow can include the modules as discussed in FIG. 5 above. For example, the second control flow can include the detector module 502, the relationship module 504, the glow module 506, the interactive module 508, or a combination thereof.

For illustrative purposes, the electronic system 100 is described with the glow module 506 generating the presentation ensemble 302 of FIG. 3, although the glow module 506 can be operated differently. For example, the glow module 506 can transmit the presentation arrangement 304 of FIG. 3 via the communication path 104 of FIG. 1 representing the mesh network. More specifically as an example, via the mesh network, the glow module 506 can determine the presentation path 708 of FIG. 7 to control the presentation direction 320 of FIG. 3 to establish order for presenting the presentation arrangement 304 from one of the first device 102 to another of the first device 102.

The glow module 506 can determine the presentation path 708 in a number of ways. As discussed above, multiple instances of the first device 102 can be laid out in rows and columns. Also as discussed above, the glow module 506 can generate the presentation arrangement 304 based on the gesture type 318, the sensing factor 204 of FIG. 2, the device orientation 328 of FIG. 3, the color model 312 of FIG. 3, or a combination thereof. For further example, the glow module 506 can determine the presentation path 708 to present the presentation ensemble 302 including the pour effect 314 of FIG. 3, the wave effect 316 of FIG. 3, the ripple effect 702 of FIG. 7, the line effect 706 of FIG. 7, or a combination thereof.

The glow module 506 can determine the presentation path 708 based on the communication path 104 representing the mesh network leveraging the routing algorithm including a flooding technique, a routing technique, a self-healing algorithm including shortest path bridging, or a combination thereof. More specifically as an example, the glow module 506 can determine the presentation path 708 by determining the shortest path 714 of FIG. 7 from the origin device 710 of FIG. 7 to the target device 712 of FIG. 7 using the routing algorithms discussed above.

The flooding technique can represent a computer network routing algorithm where incoming data packet is sent through every outgoing link except the one it arrived on. The routing technique can represent a computer network routing algorithm where the message is propagated along a path by hopping from one instance of the first device 102 to another instance of first device 102 until the message reaches the target device 712. The self-healing algorithm can represent the computer network routing algorithm that allows for continuous connection of the communication path 104 by reconfiguring the mesh network even if the presentation path 708 from the origin device 710 to the target device 712 becomes broken.

For further example, the glow module 506 of each instance of the first device 102 can determine the shortest path 714 to select the next instance of the first device 102 that will result in the shortest path 714 to reach the target device 712 using the routing algorithm discussed above. The glow module 506 can determine the presentation path 708 from any instance of the first device 102.

For example, as discussed above, multiple instances of the first device 102 can be laid out in rows and columns. The glow module 506 can determine the origin device 710 based on the gesture type 318. More specifically as an example, the gesture type 318 can change the device orientation 328 of the first device 102 in one of the row for the glow module 506 to determine the instance of the first device 102 in that row to represent the origin device 710. The target device 712 can be predefined by having one of the first device 102 being selected as the target device 712. For a different example, the origin device 710, the target device 712, or a combination thereof can be indicated by other instance of the first device 102, the second device 106 of FIG. 1, or a combination thereof with a command signal.

The glow module 506 can determine the presentation path 708 by transmitting the presentation arrangement 304 from one instance of the first device 102 to another instance of the first device 102 until the target device 712 presents the presentation arrangement 304. More specifically as an example, while the presentation arrangement 304 is being transmitted from one instance of the first device 102 to another instance of the first device 102 along the presentation path 708, the glow module 506 can present the presentation arrangement 304 on each instance of the first device 102 along the presentation path 708.

For further example, the glow module 506 can reverse the presentation path 708 to switch the origin device 710, the target device 712, or a combination thereof. More specifically as an example, once the presentation arrangement 304 is transmitted to the target device 712, the glow module 506 can reverse the presentation path 708 to transmit back the presentation arrangement 304 to the origin device 710 traversing the presentation path 708 but in reverse order. For further example, the glow module 506 can present the presentation arrangement 304 on each instance of the first device 102 along the presentation path 708 in reverse order.

For a different example, the glow module 506 can determine the presentation path 708 different from the presentation path 708 originally traversed for returning back from the target device 712 to the origin device 710. As discussed above, the glow module 506 can determine the shortest path 714 for the presentation path 708 from the target device 712 to the origin device 710. For further example, the glow module 506 can present the presentation arrangement 304 on each instance of the first device 102 along the presentation path 708.

For example, the origin device 710 can represent the master device 216. The target device 712 can represent the slave device 218. For a different example, the target device 712 can become the origin device 710 when the presentation path 708 is reversed. For further example, the target device 712 can become the master device 216 and the origin device 710 can become the slave device 218 when the presentation path 708 is reversed.

For another example, the glow module 506 can reestablish the presentation path 708 even if the presentation path 708 becomes broken. More specifically as an example, the presentation path 708 can be broken if the first device 102 along the presentation path 708 becomes inactive or missing. Based on the self-healing algorithm as discussed above, the glow module 506 can identify the next instance of the first device 102 to reestablish the presentation path 708 to reach the target device 712. The glow module 506 can present the presentation arrangement 304 on each instance of the first device 102 along the presentation path 708 that has been reestablished until reaching the target device 712. The glow module 506 can present the presentation arrangement 304 along the presentation path 708 controlled by the presentation duration 334 as discussed above.

The glow module 506 can generate the presentation ensemble 302 based on mixing or blending multiple instances of the presentation arrangement 304. More specifically as an example, multiple instances of the presentation arrangement 304 can be blended to generate the ripple effect 702 of FIG. 7, the line effect 706 of FIG. 7, or a combination thereof. The ripple effect 702, the line effect 706, or a combination thereof can include changes in the color arrangement 306 of FIG. 3, the luminosity level 308 of FIG. 3, or a combination thereof for the master device 216, the slave device 218, the origin device 710, the target device 712, or a combination thereof as discussed similarly above for the pour effect 314 of FIG. 3, the wave effect 316 of FIG. 3, or a combination thereof.

The glow module 506 can generate the ripple effect 702 by changing the device orientation 328 of one instance of the first device 102 with the gesture type 318 of tilt to trigger the presenting of the presentation arrangement 304 for other instances of the first device 102 within the communication path 104 representing the mesh network. More specifically as an example, the glow module 506 can generate the ripple effect 702 by triggering the first device 102 surrounded by the presentation boundary 704 of FIG. 7.

For further example, the glow module 506 can generate the ripple effect 702 by triggering each instance of the first device 102 in the presentation boundary 704 surrounding the first device 102 having the device orientation 328 changed. The glow module 506 can generate the ripple effect 702 by presenting the presentation arrangement 304 of each instance of the first device 102 in the presentation boundary 704 simultaneously.

More specifically as an example, multiple instances of the first device 102 can be physically laid out in 9 by 9 rows and columns. One or multiple instances of the master device 216 can be located in the center. By having the 9 by 9 rows and columns of multiple instances of the slave device 218, multiple layers of the presentation boundary 704 having the shape of square, for example, can surround the master device 216 in the center. For example, the presentation boundary 704 closest to the master device 216 in the center will be smaller than the presentation boundary 704 surrounding both the master device 216 and the presentation boundary 704 closest to the master device 216. The presentation boundary 704 can be progressively become larger to surround layers of the presentation boundary 704 closer to the master device 216 in the center.

The glow module 506 can generate the ripple effect 702 by first triggering the simultaneous presentation of the presentation arrangement 304 from each of the slave device 218 in the presentation boundary 704 closest to the mater device 216. More specifically as an example, the glow module 506 can generate the ripple effect 702 by triggering the presentation of the presentation arrangement 304 for the presentation boundary 704 closest to the master device 216 and subsequently triggering the presentation of the presentation arrangement 304 for the presentation boundary 704 in the next layer further away from the master device 216. The glow module 506 can generate the ripple effect 702 by presenting the presentation arrangement 304 one layer of the presentation boundary 704 at a time until the furthest instance of the presentation boundary 704 completes presenting.

For further example, the glow module 506 can reverse the ripple effect 702 by presenting the presentation arrangement 304 of the presentation boundary 704 by presenting the presentation arrangement 304 for the presentation boundary 704 from the furthest to closest. For another example, the glow module 506 can generate the ripple effect 702 in random order by presenting the presentation arrangement 304 at the presentation boundary 704 closest or furthest without any particular order.

The glow module 506 can generate the presentation arrangement 304 having different instances of the color arrangement 306, the luminosity level 308, or a combination thereof for each instance of the presentation boundary 704. The glow module 506 can generate the ripple effect 702 by transmitting a command signal to the master device 218 by another instance of the first device 102, the second device 106, or a combination thereof to trigger the presenting of the presentation arrangement 304.

The glow module 506 can generate the line effect 706 based on the gesture type 318, the command signal, or a combination thereof. For example, as discussed above, multiple instances of the first device 102 can be physically laid out in 9 by 9 rows and columns. The glow module 506 can generate the line effect 706 by simultaneously presenting the presentation arrangement 304 for each row or column at a time, in random order, or a combination thereof. More specifically as an example, the glow module 506 can generate the line effect 706 by presenting the presentation arrangement 304 having the presentation direction 320 from one extent of row or column to another extent of row or column one by one, in random order, or a combination thereof. For another example, the glow module 506 can generate the line effect 706 by presenting the presentation arrangement 304 having the presentation direction 320 from the center row or column to one or all extents of row or column one by one, in random order, or a combination thereof. The glow module 506 can generate the presentation arrangement 304 having different instances of the color arrangement 306, the luminosity level 308, or a combination thereof for each row or column.

What is claimed is:

1. A method of operation of an electronic system comprising:
detecting a sensing factor within a presentation context;
determining a device relationship based on the sensing factor for establishing the device relationship between multiple instances of a device; and
generating a presentation arrangement with a control unit for presenting a color arrangement at a luminosity level according to the device relationship for presenting on the device.

2. The method as claimed in claim 1 further comprising generating a presentation ensemble based on blending multiple instances of the presentation arrangement presented on each of the device.

3. The method as claimed in claim 1 wherein determining the device relationship includes determining the device relationship for identifying one instance of the device as a master device and another instance of the device as a slave device.

4. The method as claimed in claim 1 wherein generating the presentation arrangement includes generating a color arrangement by controlling a color emitted by each instance of a lighting source.

5. The method as claimed in claim 1 wherein generating the presentation arrangement includes generating the presentation arrangement based on a gesture type for changing a device orientation of a device.

6. The method as claimed in claim 1 further comprising updating the presentation arrangement based on an orientation change degree meets or exceeds an orientation threshold.

7. The method as claimed in claim 1 further comprising determining the presentation arrangement based on a device altitude for updating the color arrangement, the luminosity level, or a combination thereof emitted by the device.

8. The method as claimed in claim 1 further comprising determining the presentation arrangement based on a device contact for updating the color arrangement, the luminosity level, or a combination thereof when the device contact is detected on a surface point, a device surface, or a combination thereof of the device.

9. The method as claimed in claim 1 further comprising generating a pour effect for sharing the presentation arrangement of a master device to a slave device according to a presentation direction.

10. The method as claimed in claim 1 further comprising generating a wave effect for sharing the presentation arrangement of a master device to multiple instances of a slave device in random order.

11. The method as claimed in claim 1 further comprising generating a ripple effect for presenting the presentation arrangement originating from a master device to a slave device in multiple instances of a presentation direction.

12. The method as claimed in claim 1 further comprising generating a line effect for presenting multiple instances of the presentation arrangement arranged in a row, a column, or a combination thereof.

13. The method as claimed in claim 1 further comprising determining a presentation path for presenting the presentation arrangement at each instance of the device in between an origin device and a target device.

14. An electronic system comprising:
a detecting sensor for detecting a sensing factor within a presentation context; and
a control unit, coupled to the detecting sensor, for:
determining a device relationship based on the sensing factor for establishing the device relationship between multiple instances of a device, and
generating a presentation arrangement with a control unit for presenting a color arrangement at a luminosity intensity according to the device relationship for presenting on the device.

15. The system as claimed in claim 14 wherein the control unit is for generating a presentation ensemble based on blending multiple instances of the presentation arrangement presented on each of the device.

16. The system as claimed in claim 14 wherein the control unit is for determining the device relationship for identifying one instance of the device as a master device and another instance of the device as a slave device.

17. The system as claimed in claim 14 wherein the control unit is for generating a color arrangement by controlling a color emitted by each instance of a lighting source.

18. The system as claimed in claim 14 wherein the control unit is for generating the presentation arrangement based on a gesture type for changing a device orientation of a device.

19. A non-transitory computer readable medium including instructions for execution, the instructions comprising:
detecting a sensing factor within a presentation context;
determining a device relationship based on the sensing factor for establishing the device relationship between multiple instances of a device; and
generating a presentation arrangement with a control unit for presenting a color arrangement at a luminosity intensity according to the device relationship for presenting on the device.

20. The non-transitory computer readable medium as claimed in claim 19 further comprising generating a presentation ensemble based on blending multiple instances of the presentation arrangement presented on each of the device.

21. The non-transitory computer readable medium as claimed in claim 19 wherein determining the device relationship includes determining the device relationship for identifying one instance of the device as a master device and another instance of the device as a slave device.

22. The non-transitory computer readable medium as claimed in claim 19 wherein generating the presentation arrangement includes generating a color arrangement by controlling a color emitted by each instance of a lighting source.

23. The non-transitory computer readable medium as claimed in claim 19 wherein generating the presentation arrangement includes generating the presentation arrangement based on a gesture type for changing a device orientation of a device.
